(19) United States
(12) Patent Application Publication
(10) Pub. No.: US 2026/0153225 A1
(43) Pub. Date: Jun. 4, 2026

(54) TRACKING MIRROR

(71) Applicant: Kohler Co., Kohler, WI (US)

(72) Inventors: Jason M. Kwacz, Kohler, WI (US); Penn Zha, Shanghai (CN); Johnson Zhuang, Shanghai (CN); Alan Yao, Shanghai (CN); Kor Han Chew, Shanghai (CN); Yorke Gao, Shanghai (CN)

(21) Appl. No.: 19/386,977

(22) Filed: Nov. 12, 2025

Related U.S. Application Data
(60) Provisional application No. 63/727,404, filed on Dec. 3, 2024.

(51) Int. Cl. F21V 14/02; F21V 5/04; F21V 33/00; F21W 131/302; G01S 13/72; G06T 7/50; G06T 7/73

(52) U.S. Cl. CPC F21V 14/02; F21V 5/04; F21V 33/0012; G01S 13/72; G06T 7/50; G06T 7/73; F21W 2131/302; G06T 2207/30201

(57) ABSTRACT

An apparatus includes a mirror, a sensor configured to generate position data of at least one object associated with the mirror, a controller configured to receive the position data and generate a drive command in response to the position data, and at least one light configured to move in response to the drive command.

### CROSS-REFERENCE TO RELATED APPLICATIONS

This application claims priority benefit of Provisional Application No. 63/727,404 (Docket No. 010222-24029A-US) filed on Dec. 3, 2024, which is hereby incorporated by reference in its entirety.

### FIELD

The present application relates to a lighting system for a mirror.

### BACKGROUND

Generally, lighted mirrors may be used in applications in which a user intends to perform detailed work (e.g., cosmetic applications) or carefully inspect one or more physical features (e.g., cosmetic, hygienic applications). It is preferential that light generated by the mirror be directed toward and illuminate the user. Accordingly, there is a need for a lighted mirror that directs light toward a user in all circumstances.

### BRIEF DESCRIPTION OF THE FIGURES

In order to illustrate the technical solutions in the embodiments of the present disclosure more clearly, the drawings used in the description of the embodiments are briefly described below. Apparently, the drawings in the following description are merely some embodiments of the present disclosure. For those of ordinary skills in the art, other drawings may also be obtained based on these drawings without any creative work and should fall within the scope of protection of the present disclosure.

FIG. 1 illustrates a mirror including an adjacent dark zone;

FIG. 2 illustrates an example mirror according to one embodiment of the present disclosure;

FIG. 3 illustrates an example mirror according to another embodiment of the present disclosure;

FIG. 4 illustrates a side view of the mirror of FIG. 3;

FIG. 5 illustrates a first section in detail from the side view of the mirror of FIG. 3;

FIG. 6 illustrates a second section in detail from the side view of the mirror of FIG. 3;

FIG. 7 illustrates a third section in detail from the side view of the mirror of FIG. 3;

FIG. 8 illustrates an example mirror according to another embodiment of the present disclosure;

FIG. 9 illustrates an example mirror according to another embodiment of the present disclosure;

FIG. 10 illustrates an example block diagram for the tracking mirror;

FIG. 11 illustrates another example block diagram for the tracking mirror;

FIG. 12 illustrates another example block diagram for the tracking mirror;

FIG. 13 illustrates an example detailed block diagram for the control system and/or control unit; and

FIG. 14 illustrates an example flowchart for the control system.

### DETAILED DESCRIPTION

For better understanding the present disclosure, the technical solutions in the embodiments of the present disclosure are clearly and completely described hereinafter with reference to the drawings in the embodiments of the present disclosure. It should be apparent that the described embodiments are merely some rather than all embodiments of the present disclosure. Based on the embodiments of the present disclosure, all other embodiments obtained by those having ordinary skills in the art without going through any creative work should fall within the scope of protection of the present disclosure.

The terms “first”, “second”, “third” and the like in the specification, claims and drawings of the present disclosure are used to distinguish different objects, and are not used to describe a specific sequence. Furthermore, those terms “including” and “provided with” and any variations thereof are intended to cover non-exclusive inclusion. For example, processes, methods, apparatuses, products, or devices including a series of steps or units are not limited to the listed steps or units, but optionally include steps or units not listed, or optionally include other steps or units inherent to these processes, methods, products, or devices.

By way of introduction, the present disclosure includes lighted mirrors and methods of illuminating users or other objects adjacent to lighted mirrors. Specifically, described herein are lighted mirrors including a light that is adjusted in response to detection of a user or other object in proximity to the lighted mirror. Adjusting the path of the light generated for the mirror allows more light energy to be directed toward a user improving the efficiency of the mirror assembly and increasing illuminance of the user. Specifically, the described lighted mirrors and methods of illuminating a user may achieve illumination of the user in which a primary path of light uses substantially less electrical power than would otherwise be used without adjustment of the light.

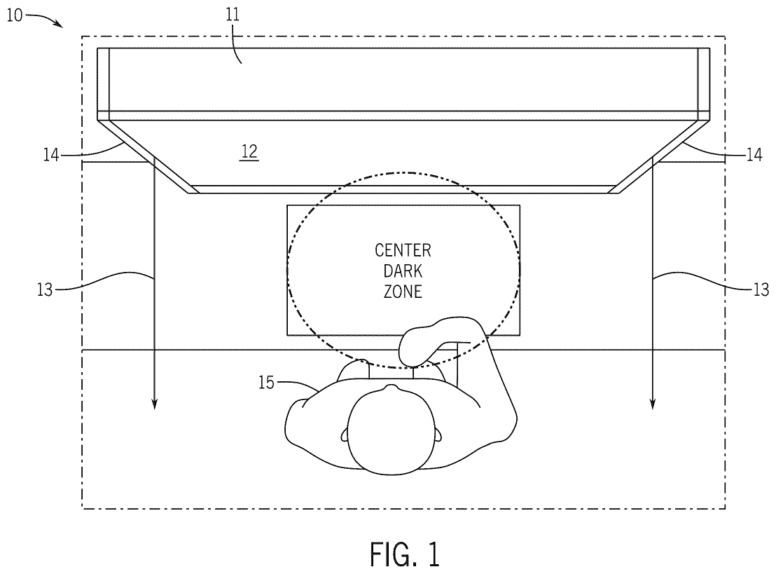

FIG. 1 illustrates a mirror assembly 10 having a cabinet 11 and a mirrored surface 12. One or more lights 14 are mounted adjacent to the mirrored surface 12. As shown by arrows 13, the one or more lights 14 project generally perpendicularly outward from the mirrored surface 12. A user 15 positioned directly in front of the mirrored surface 12 may be in a center dark zone between the projected beams of light, as shown by arrows 13. In some examples, the light produced by the one or more lights 14 is inadequate to illuminate the user 15 for certain functions such as hygiene or cosmetic/makeup applications. To provide adequate light to the center dark zone including the user 15, brighter or more intense light must be produced by the one or more lights 14. This may consume more electrical power than necessary. The following embodiments provide selective control to the direction and properties of the light in order to provide a better user experience and conserve electrical power.

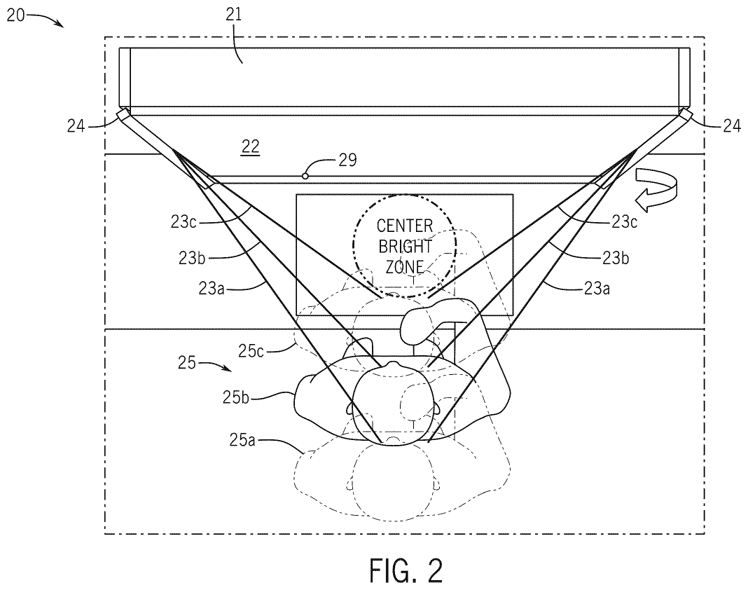

FIG. 2 illustrates an example mirror assembly 20 having a cabinet 21 and a mirrored surface 22. One or more lights 24 are mounted adjacent to the mirror surface 22. As shown by arrows 23, the direction of the one or more lights 24 may be adjusted to point at different angles. For example a small angle set of arrows 23c corresponds to a close position of the user 25c, a medium angle set of arrows 23b corresponds to a medium position of the user 25b, and a wide angle set of arrows 23a corresponds to a far position of the user 25a.

Thus, the user 25 positioned in front of the mirror surface 22 may receive the projected beams of light directly. The one or more lights 24 may be adjusted in position based on sensor data collected in proximity to the mirror assembly 20. While the user 25 is illustrated as an example, other objects may be associated with the mirror assembly 20 and the one or more lights 24 may be aimed at the other objects based on the detected position of the other objects. Example other objects may include another mirror to see around a corner. Additional, different or fewer components may be included.

A sensor 29 may detect the user 25 in a variety of techniques. More than one sensor 29 may be used. The sensors 29 may be placed in a variety of locations with respect to the mirror assembly 20. One example placement is illustrated in FIG. 2. The sensor 29 may include a motion sensor or a position sensor. The sensor 29 may generate sensor data that describes the distance to the user 25 from the mirror assembly 20. The sensor 29 may generate sensor data that describes an angle to the user 25 from the one or more lights 24.

The sensor 29 may include a time of flight sensor as a proximity sensor. The time of flight sensor may emit a light pulse or another type of pulse that travels to the user 25 and is reflected back from the user 25. The time for the light pulse or other pulse to travel the roundtrip distance is used to calculate the distance to the user 25. One example of the time of flight sensor is a light detection and ranging (LiDAR) sensor. The LiDAR sensor may emit light such as visible light, ultraviolet light, or near infrared light to an object and receive the reflected light from the object. The LiDAR sensor may use a laser for precise measurements.

The sensor 29 may include a camera. The camera 29 may collect images of the user 25. A computer analysis, or image processing technique, may be applied to the collected images in order to determine or estimate the distance to the user 25. The distance may be determined from a height in pixels or an area in pixels corresponding to the user 25 within the image. In one example, the images are analyzed to identify a face of the user 25. The face of the user 25 may be the object that is tracked by the mirror assembly 20. The images may be analyzed to identify other objects such as another part of the user's body. In one example, the images are analyzed to identify an identity of the user. When two or more users are in the range of the sensor 29 and/or the light 24, a particular user is selected, and the selected is tracked and followed by the light 24.

As another type of image sensor, the sensor 29 may include a CMOS image sensor. The CMOS sensor may be a semiconductor chip configured to collect images of the user or other objects by detecting light, which is collected by a lens and converted to electrical signals for each pixel or group of pixels by the CMOS sensor. The sensor 29 may include a combination of any of the above sensors.

The sensor 29 may include an infrared transmitter and infrared depth sensor that measured distance to the user 25 by projecting infrared beams and measuring the amount of time for the infrared beams to reflect off the user and be detected by the sensor 29. The infrared sensor and transmitter may be used in conjunction with a camera or other sensor to track multiple points on the user 25 simultaneously. In this way, the sensor 29 may track the face of the user so that the light 24 can be operated to track the user 25 in real time.

The sensor 29 may include a microwave radar sensor that emits electromagnetic wave signals and receives electromagnetic wave echo signals reflected by targets. Millimeter wave radar sensor with FMCW (Frequency Modulated Continuous Wave) technology is a high-precision radar ranging technology that generates an intermediate frequency signal with target distance and signal strength after mixing the microwave transmitted wave with the reflected wave of the target through a radio frequency (RF) circuit. The intermediate frequency signal is processed to obtain the distance and/or speed of the target. Based on these behavioral characteristics of target, the sensor 29 identifies the user in proximity to the mirror assembly 40. The microwave radar sensor is configured to detect the presence of one or more objects or motion of one or more objects. The microwave radar sensor may be included in a controller according to the following embodiments, which includes a millimeter wave sensor module, a microcontroller unit (MCU), a solenoid valve or other type of valve, and at least one power supply or power supply circuit. In one example, millimeter wave control unit, the microwave operating frequency can be selected as either 24 GHz or 60/77 GHz, with no frequency restrictions. The millimeter wave sensor control device may include a transmission antenna (Tx chirp) that transmits millimeter wave signal. A receiving antenna of the millimeter wave sensor module receives reflected waves (Rx chirp) when there is a user in the range. The emitted wave and reflected wave are mixed in the mixer to generate an intermediate frequency signal in the millimeter wave sensor. The MCU of the millimeter wave sensor performs fast Fourier transform (FFT) operation on the intermediate frequency signal to obtain the distance and velocity information of the targets.

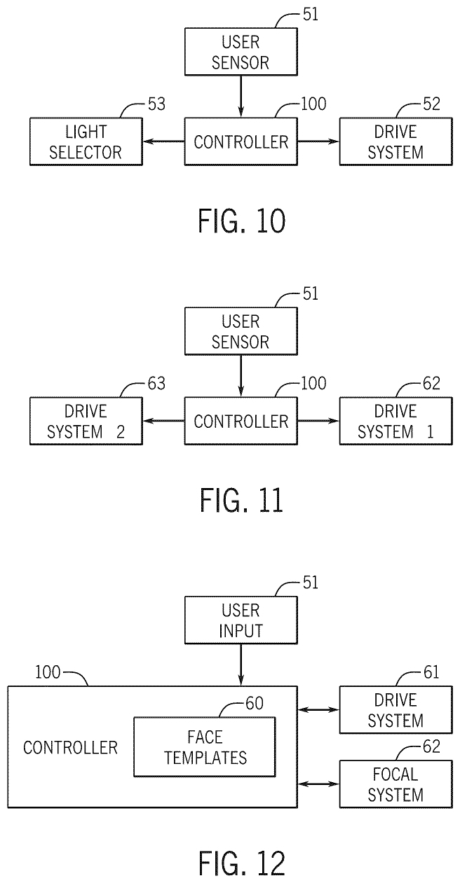

A controller 100, as shown in various examples of FIGS. 10-13, may analyze the sensor data 29 and control the one or more lights 24 in response to the sensor data. For example, the controller 100 may be configured to receive the position data for the user 25 and generate a drive command for the one or more lights 24 in response to the position data. The drive command may operate a drive mechanism that repositions the one or more lights 24. The drive command may set an absolute position (e.g., an angle or a step motor position) for the one or more lights 24. The one or more lights 24 may be any quantity of lights. The one or more lights 24 may include a first light that is positioned to a first light position and a second light that is positioned to a second light position.

The drive command may operate a lens mechanism that adjusts a focal point or focal distance of the one or more lights 24. For example a lens may be rotated to enlarge or reduce in size the size of the light beam when it reaches the object. The drive command may include a rotation angle for the lens.

In another example, a relative change in the distance to the user 25 is calculated. As shown in FIG. 2, the user may move from a first position 25a (at a first, longer distance from the mirror surface 22 and/or the sensor 29) to a second position 25b (at a second, closer distance to the mirror surface 22 and/or the sensor 29). The drive command from the controller 100 may include a relative position (e.g., a change in position, a change in an angle, or a step motor adjustment) to move each of the one or more lights 24 a relative amount in response to the movement of the user 25. In this way, the one or more lights 24 track the user moving from the second position 25b to the first position 25a as well as any variety of positions.

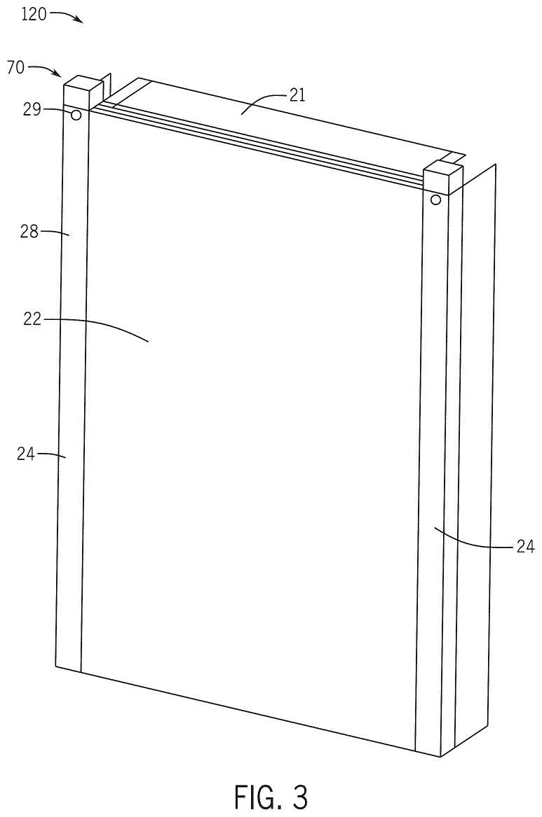

FIGS. 3-7 illustrate another example embodiment of mirror assembly 120. As shown in the perspective view of FIG. 3, the mirror assembly 120 includes a cabinet 21 and a mirrored surface 22. A lighting and sensing assembly 70 is coupled to the sides of the cabinet 21. The lighting and sensing assembly 70 includes the lights 24 and the sensor 29. The lights 24 may be mounted within a cavity of the mirror assembly 120. For example, the lights 24 may be supported behind a diffuser (e.g., a lampshade 78) such as a transparent, semi-transparent, or translucent material in a light housing 28. The light 24 and sensor 29 may both be mounted in the housing 28. The housing 28 may be divided into a first sub-housing for the light 24 and a second sub-housing for the sensor 29. Additional, different or fewer components may be included.

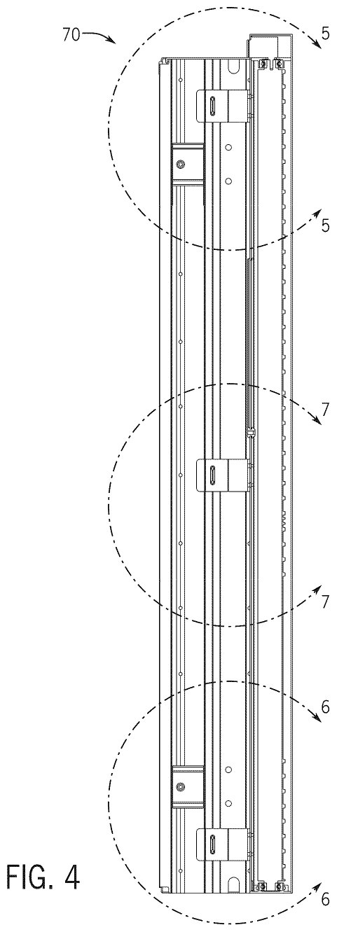

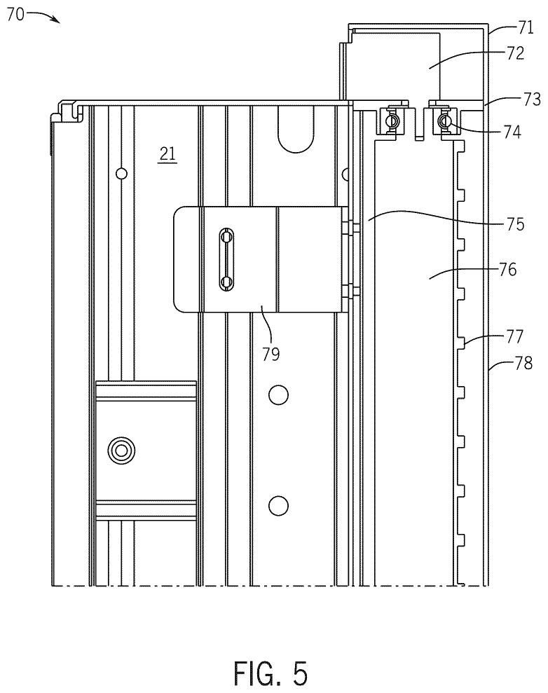

As shown in FIG. 4, the side view of the mirror assembly 120 illustrates three sections. FIG. 5 illustrates a section for a top portion of the mirror assembly 120 includes an upper cover 71, a motor 72, a support plate 73, a bearing 74, a fixation bracket 75, a rotation bracket 76, a LED strip 77, a lampshade 78, and at least one mounting bracket 79. As illustrated in FIG. 4 three mounting brackets 79 may couple the Additional, different or fewer components may be included.

The upper cover 71 is a frame or housing that is coupled to one or more other components of the mirror assembly 120. For example, the upper cover 71 may be coupled to the door and the cabinet.

The motor 72 may be coupled to the lights 24 and be configured to rotate or otherwise adjust the angle of the lights 24. For example, the motor 72 may rotate the lights within the light housing 28. In one example, the motor 72 is coupled to a rotation bracket 76. The rotation bracket 76 pivots with respect to a fixation bracket 75, which is coupled to the cabinet 21 of the mirror assembly 120. The rotation bracket 76 is coupled to and supports at least one light 24, which may include a light emitting diode (LED) 77 or a strip of LEDs. The strip of LEDs may be implements using a printer circuit board that glued, fastened, or otherwise secured to the rotation bracket 76. The rotation bracket 76 may be coupled to a bearing 74, which provides rotatable support to facilitate the rotation of the rotation bracket 76 under the force of the motor 72. The support plate 73 may support the motor 72, the support plate 73, and/or the bearing 74.

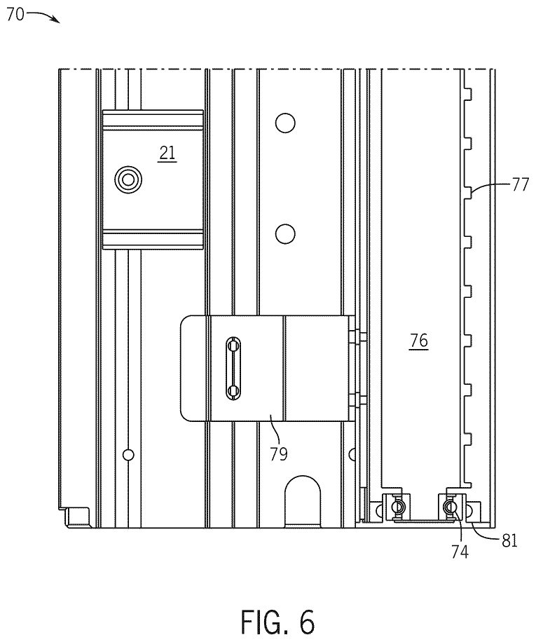

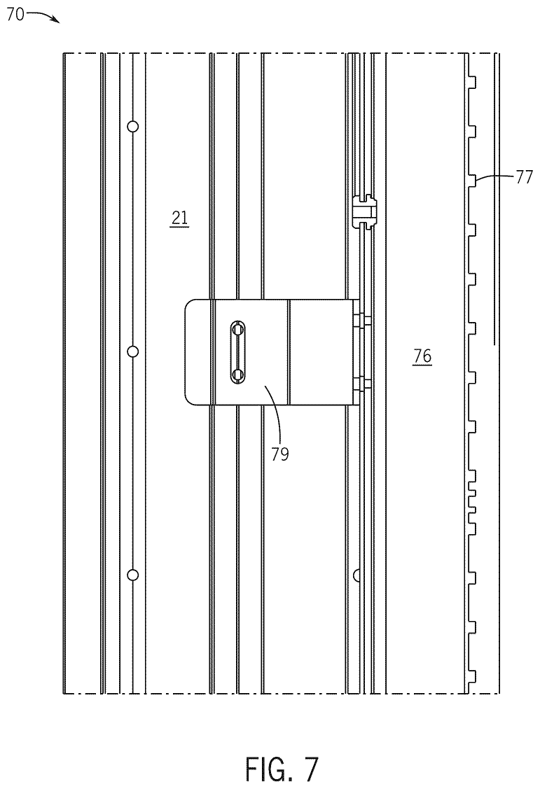

FIG. 6 illustrates that the bottom of the lighting and sensing assembly 70 may also include a lower cover 81 and a bearing 74 to support the rotation bracket 76. A mounting bracket 79 may also be included in the bottom portion of the cabinet 21 to couple and support the lighting and sensing assembly 70. FIG. 7 illustrates another bracket 79 in the middle portion of the cabinet 21 to couple and support the lighting and sensing assembly 70.

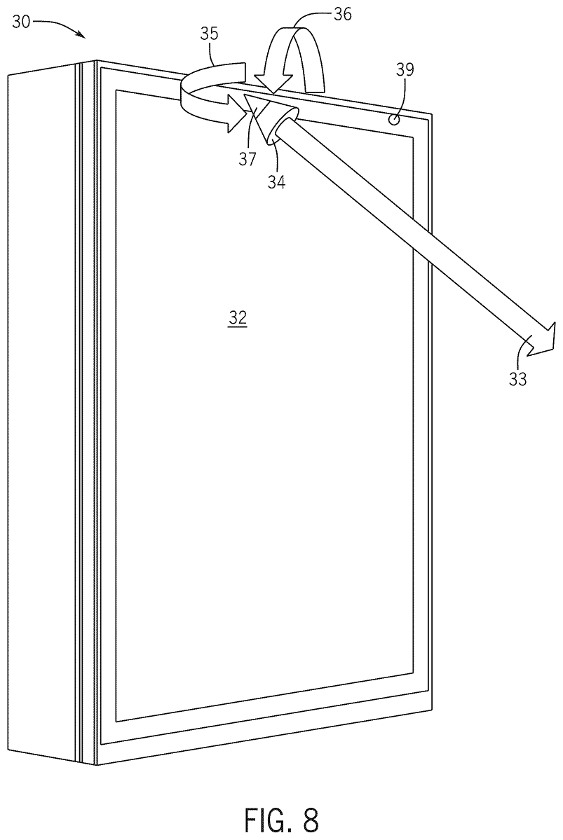

FIG. 8 illustrates an example mirror 30 according to another embodiment of the present disclosure. The mirror 30 includes a mirror surface 32, at least one sensor 39, and at least on light 34. Additional, different or fewer components may be included.

A drive mechanism operates the light 34 to swivel about at least two directions. As illustrated in FIG. 8, the drive mechanism may translate, slide or pivot the light 34 in a first direction or about a first axis 35 such as a horizontal direction or a pivot point on a horizontal dimension, and the drive mechanism may translate, slide or pivot the light 34 in a second direction or about a second axis 36 such as a vertical direction or a pivot point on a vertical dimension.

The drive command from the controller may include two components. One component corresponds to movement of the light to a first axis position or first axis coordinate. Another component corresponds to movement of the light to a second axis position or second axis coordinate. Each component may specify a swivel angle and or a rotation angle for the light 34.

A light mount 37 is configured to support the light 34. The light mount 37 may include an internal drive mechanism (e.g., one or more motors or solenoids) configured to receive the drive command and operate the light 34 in response to the drive command. The light mount 37 may include a ball and socket pivot joint. The light mount 37 may include a rack and pinion gear system. In some examples, the light mount 37 is configured to support multiple lights 34. For example, when the at least one light 34 includes a first light and a second light, the light mount 37 may include a first light mount for the first light and a second light mount for the second light. The first light mount may operate independently (e.g., at different positions and/or different angles at the same time) from the second light mount. For example, the first light mount is configured to aim the first light at a first angle in response to the drive command and the second light mount aim the second light at a second angle in response to the drive command.

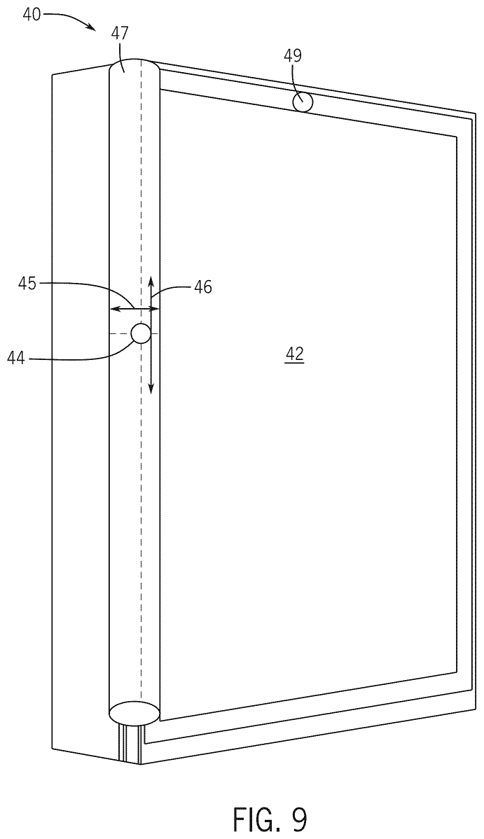

FIG. 9 illustrates an example mirror assembly 40 according to another embodiment of the present disclosure. The mirror assembly 40 includes a mirror surface 42, a sensor 49, and a drive mechanism for at least one light 44. Additional, different or fewer components may be included.

The drive mechanism may include a housing 47 that supports and encloses one or more drive trains. One drive train (e.g., a first drive train) may operate in a horizontal direction, as shown by arrow 45. One drive train (e.g., a second drive train) may operate in a vertical direction, as shown by arrow 46. The light 44 may be supported by a drive carriage that is moved along the first drive train and the second drive train.

In one example, a pulley or a gear track moves the light 44 vertically along the second drive train. A motor may rotate the light 44 around the first drive train. In this way the light 44 may be operated at any height along the mirror assembly 40 and at any angle in the reflection field of the mirror surface 42 and/or in the range of the sensor 49.

FIGS. 10-12 illustrate example block diagrams for the tracking mirror.

FIG. 10 illustrates an example block diagram for the tracking mirror including a user sensor 51, a light selector 53, and a drive mechanism 52 connected to a controller 100. As described above, the controller 100 receives sensor data from the user sensor 51 and analyzes the sensor data to determine one or more drive mechanism commands to instruct the drive mechanism 52 to position a light at the detected position of the face of a user. In addition, the controller 100 may analyze the sensor data to determine one or more properties of the light that is directed to the position of the face of the user. The property of the light may be intensity. The intensity may be selected based on the distance to the face of the user. The property of the light may be beam size. The beam size may be selected according to the size of the face of the user. The property may be color. The color may be selected according to user preference or a complexion of the user.

FIG. 11 illustrates another example block diagram for the tracking mirror including a user sensor 51 and two drive mechanisms 62 and 63 connected to a controller 100. As described above, the controller 100 receives sensor data from the user sensor 51 and analyzes the sensor data to determine one or more drive mechanism commands for each of the two drive mechanisms 62 and 63 to position the light at the detected position of the face of a user.

FIG. 12 illustrates another example block diagram for the tracking mirror including a user sensor 51, a drive system 61 and a focal system 62 connected to a controller 100 having a database of face tracking templates 60. Additional, different or fewer components may be included.

The controller 100 may include or otherwise be in communication with a memory configured to store face tracking templates. Each face tracking template may define one or more points that form the contour of a user's face. The face tracking templates may describe different orientations, positions, or angles for a face. The face tracking templates may describe faces at different distances from the mirror. The face tracking templates may describe the faces of different users registered with the mirror.

The controller 100 is configured to receive the sensor data for the user and compare the sensor data to the face tracking templates stored in memory. When the user sensor 51 is a camera, the sensor data is image data, and the controller 100 compares one or more image points in the image data to points in the face tracking templates. In response to the comparison, the controller 100 determines the orientation and/or position of the user's face. The controller 100 generates a drive command for the light in response to the comparison. For example, the drive command may steer the light to illuminate a face identified from the comparison of the image data with the face tracking templates.

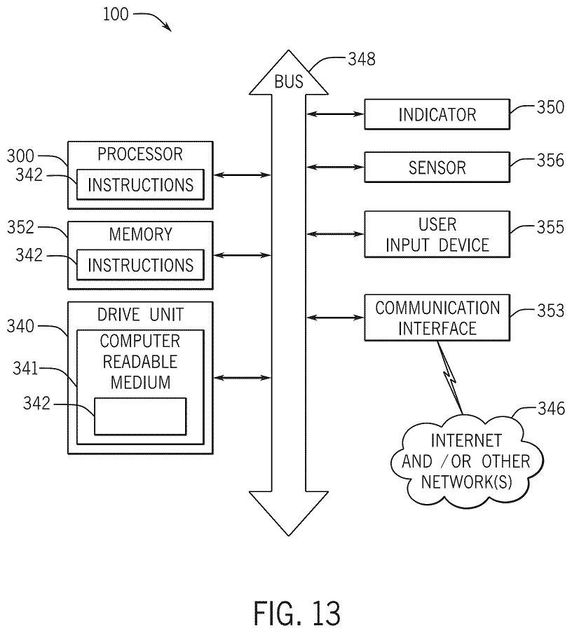

FIG. 13 illustrates an example detailed block diagram for the controller 100, which may be implemented by any of the embodiments described herein. The controller 100 may include a processor 300, a memory 352, and a communication interface 353 for interfacing with devices or to the internet and/or other networks 346. In addition to the communication interface 353, a sensor interface may be configured to receive data from the sensors described herein or data from any source. The controller 100 may include an integrated an indicator (e.g., display, LED, speaker, or other output devices). The components of the control system may communicate using bus 348. The control system may be connected to a workstation or another external device (e.g., control panel) and/or a database for receiving user inputs, system characteristics, durations and any of the thresholds described herein.

Optionally, the control system may include an input device 355 and/or a sensing circuit 356 in communication with any of the sensors such as sensor 29. The sensing circuit receives sensor measurements from sensors as described above. The input device 355 may alternatively include one or more user inputs such as buttons, touchscreen, a keyboard, a microphone or other mechanism for calibrated any of the system characteristics, durations and any of the thresholds described herein.

Optionally, the control system may include a drive unit 340 for receiving and reading non-transitory computer media 341 having instructions 342. Additional, different, or fewer components may be included. The processor 300 is configured to perform instructions 342 stored in memory 352 for executing the algorithms described herein.

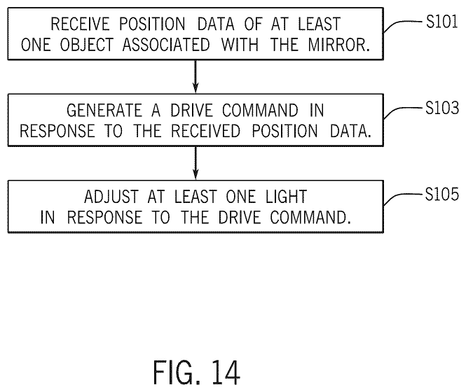

FIG. 14 illustrates an example flowchart for the controller 100 according to any of the embodiments described herein. Additional, different or fewer acts may be included.

At act S101, the controller 100 (e.g., processor 300) receives position data of at least one object associated with a mirror. The controller 100 may detect the closest object to the mirror surface. The controller 100 may select an object in a region-of-interest defined by a predetermined distance range. The distance range may be determined as a function of the size of the mirror. In one example, the position data is arranged in a point cloud. The controller 100 may filter the point cloud according to one or more factors such as distance, density, cluster size, or others.

At act S103, the controller 100 (e.g., processor 300) generates a drive command in response to the received position data. The drive command may cause a drive mechanism such as a motor to rotate. The drive command may cause a lens to move or rotate. The drive command may adjust a parameter of a electrical power source for the light.

At act S105, the controller 100 (e.g., processor 300) sends the drive command to one or more device to adjust at least one light in response to the drive command. In one example, the adjustment may cause the at least one light to move a first direction (e.g., lateral or translation direction). In one example, the adjustment may cause the at least one light to move in a second direction (e.g., rotation direction). In one example, the adjustment may cause the at least one light to swivel. In one example, the adjustment may change the focal distance for the at least one light.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, the memory 352 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. An apparatus comprising:
a mirror;
a microwave sensor configured to generate position data of at least one object associated with the mirror;
a controller configured to receive the position data and generate a drive command to track the at least one object in response to the position data from the microwave sensor; and
at least one light configured to move in response to the drive command.

2. The apparatus of claim 1, further comprising:
a motor configured to move the at least one light according to the drive command.

3. The apparatus of claim 1, wherein the at least one light focuses to a focal distance in response to the drive command.

4. The apparatus of claim 1, wherein the at least one light is moved to an angle in response to the drive command.

5. The apparatus of claim 1, further comprising:
at least one light mount configured to support the light and swivel in response to the drive command.

6. The apparatus of claim 5, wherein the at least one light includes a first light and a second light and the at least one light mount includes a first light mount and a second light mount.

7. The apparatus of claim 6, wherein the first light mount points the first light at a first angle in response to the drive command and the second light mount points the second light at a second angle in response to the drive command.

8. The apparatus of claim 1, wherein the drive command directs the at least one light to the at least one object associated with the mirror.

9. The apparatus of claim 1, wherein the sensor is configured to generate image data for the at least one object.

10. The apparatus of claim 9, wherein the controller compares the image data to at least one face tracking template.

11. The apparatus of claim 10, wherein the drive command directs the at least one light to a face identified from the at least one face tracking template.

12. The apparatus of claim 1, further comprising:
a lens configured to direct a beam from the at least one light to a focal point.

13. The apparatus of claim 12, wherein the controller is configured to select the focal point in response to the position data.

14. The apparatus of claim 1, further comprising:
a face template database configured to store a plurality of face templates.

15. The apparatus of claim 14, wherein the controller compares the position data to the plurality of face templates to identify the at least one object associated with the mirror.

16. A method comprising:
receiving, from a microwave radar sensor, position data of at least one object associated with a mirror;
generating a drive command in response to the received position data; and
adjusting at least one light in response to the drive command.

17. The method of claim 16, wherein the at least one light comprises:
moving the at least one light in a first direction.

18. The method of claim 16, wherein the at least one light comprises:
swiveling the at least one light in a second direction.

19. The method of claim 16, wherein the at least one light comprises:
adjusting a focal distance of the at least one light.

20. A controller for a face tracking mirror, the controller comprising:
a memory including a plurality of face tracking templates; and
a controller configured to receive sensor data and generate a drive command in response to the sensor data, wherein at least one light is adjusted in response to the drive command.
